(19) United States
(12) Patent Application Publication
(10) Pub. No.: US 2008/0005266 A1
(43) Pub. Date: Jan. 3, 2008

(54) MULTIMEDIA DELIVERY SYSTEM

(76) Inventors: Gene Fein, Lenox, MA (US); Edward Merritt, Lenox, MA (US)

Correspondence Address: BERKELEY LAW & TECHNOLOGY GROUP, LLP, 17933 NW Evergreen Parkway, Suite 250, BEAVERTON, OR, 97006, US

(21) Appl. No.: 11/428,197

(22) Filed: Jun. 30, 2006

(51) Int. Cl. G06F 15/16

(52) U.S. Cl. 709/217

(57) ABSTRACT

Disclosed is a system and method. The system and method may facilitate transmitting of an indication of a selection of a multimedia. Additionally, the system and method may facilitate reception of a storage medium having the selected multimedia.

### BACKGROUND

1. Technical Field

The subject matter disclosed herein generally relates to delivery of multimedia.

2. Information

A person may prefer to experience multimedia, such as a television program, during a time when it may be considered more convenient for the person. For example, a person may view a television program at a time that is different than the program's broadcast time (i.e., time shift).

In order to facilitate a time shift, a digital video recorder (DVR) may be utilized. However, DVRs may require relatively complicated interaction, and since DVRs commonly include a finite storage capacity for recording various media, management of the storage capacity may also be a component of the complicated interaction. Additionally, a recurring fee may be associated with the utilization of a DVR device.

### BRIEF DESCRIPTION OF THE DRAWINGS

Embodiments are illustrated by way of example and not by way of limitation in the figures of the accompanying drawings, in which like references may indicate similar elements and in which:

FIG. 1 illustrates a system for delivery of multimedia in accordance with one embodiment;

FIG. 2 illustrates a multimedia delivery system in accordance with another embodiment;

FIG. 3 illustrates an operational flow of a multimedia system in accordance with one embodiment;

FIG. 4 illustrates an operational flow of a multimedia system in accordance with another embodiment;

FIG. 5 illustrates a multimedia component in accordance with one embodiment of the claimed subject matter;

FIG. 6 illustrates a multimedia component in accordance with another embodiment of the claimed subject matter;

FIG. 7 illustrates a multimedia component in accordance with yet another embodiment of the claimed subject matter; and

FIG. 8 illustrates an embodiment of a multimedia delivery system in accordance with one embodiment of the claimed subject matter.

### DETAILED DESCRIPTION

In the following description, embodiments will be disclosed. For purposes of explanation, specific numbers, materials, and/or configurations are set forth in order to provide a thorough understanding of the embodiments. However, it will also be apparent to one skilled in the art that the embodiments may be practiced without one or more of the specific details, or with other approaches, materials, components, etc. In other instances, well-known structures, materials, and/or operations are not shown and/or described in detail to avoid obscuring the embodiments. Accordingly, in some instances, features are omitted and/or simplified in order to not obscure the disclosed embodiments. Furthermore, it is understood that the embodiments shown in the figures are illustrative representations and are not necessarily drawn to scale.

References throughout this specification to “one embodiment” or “an embodiment” means that a particular feature, structure, material, and/or characteristic described in connection with the embodiment is included in at least one embodiment. Thus, the appearances of the phrases “in one embodiment” and/or “in an embodiment” in various places throughout this specification are not necessarily all referring to the same embodiment. Furthermore, the particular features, structures, materials, and/or characteristics may be combined in any suitable manner in one or more embodiments.

For the purposes of the subject matter disclosed herein, storage medium may include a storage medium that may utilize a wide variety of recording formats such as, but not limited to, digital videodisc or digital versatile disc (DVD) and its many permutation (e.g., DVD-ROM, DVD-RAM, DVD-R, DVD-RW, DVD+R, etc.), compact disc (CD) and its many permutations (e.g., CD-R, CD-RW, CD-ROM, etc.), Blu-ray disc, high density digital versatile disc or high definition digital video disc (HDDVD), and so forth. Further, it should be appreciated that storage medium may also include a wide variety of hardware type storage devices such as, but not limited to, flash type memory devices including various random-access memory (RAM) type devices (e.g., DRAM, SDRAM), various read only memory type devices (e.g., PROM, EEPROM), etc. Accordingly, the claimed subject matter is not limited to a particular type of storage medium.

For the purposes of the subject matter disclosed herein, audio/visual material may include a wide variety of audio visual material such as, but not limited to, broadcast type material (e.g., television programs, audio programs, multi-media programs, etch), and accordingly, the subject matter is not limited in these respects.

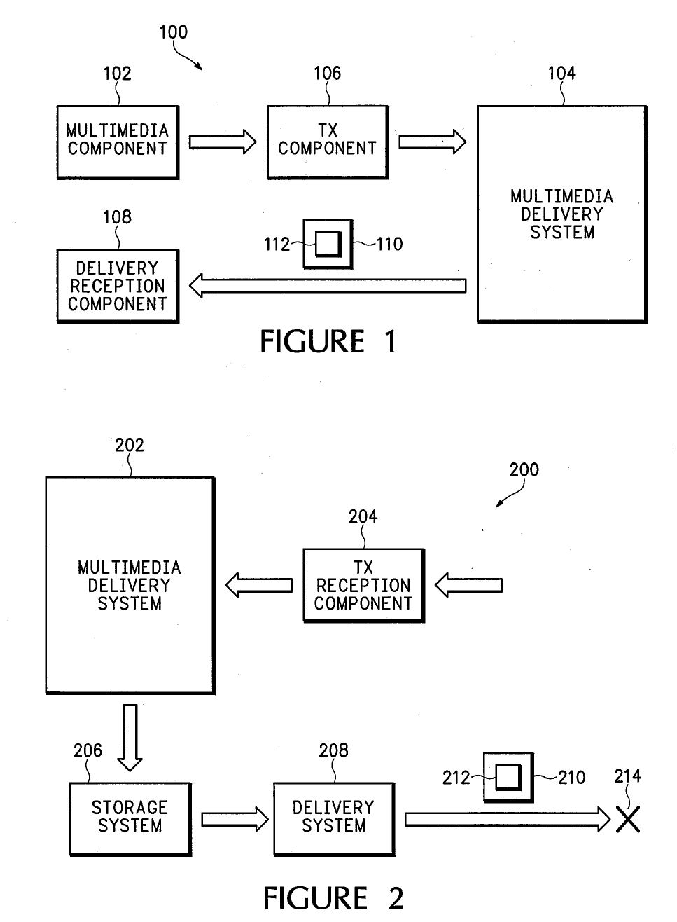

Turning now to the figures. FIG, 1 illustrates a system for delivery of multimedia in accordance with one embodiment. In FIG. 1, system 100 may include a multimedia component 102, a multimedia delivery system 104, a transmission component 106, and a delivery reception component 108. As illustrated, transmission component 106 may be communicatively coupled with multimedia component 102 and multimedia delivery system 104. Additionally, shown in FIG. 1, system 100 may include a storage medium 110, which may optionally include a tracking type device 112. As will be described in detail, system 100 facilitates delivery of multimedia in accordance with an embodiment of the claimed subject matter.

In the embodiment illustrated, multimedia component 102 may be capable of providing multimedia to a user (not shown). Transmission component 106 may be capable of transmitting an indication of a selection of multimedia to the multimedia delivery system 104. Multimedia delivery system 104 may facilitate storing of the selected multimedia. The selected multimedia may be stored on a storage medium 110. As shown, storage medium 110, having the selected multimedia, may be delivered to delivery reception component 108.

Continuing to refer to FIG. 1, as previously alluded to, multimedia component 102 may include a wide variety of multimedia components such as, but not limited to, a television type device, a stereo receiver type device, a radio type device, a computer type device, a digital music player type device, and so forth, and claimed subject matter is not limited in these respects. Accordingly, transmission component 106 may also include a wide variety of transmission type components such as, but not limited to, transmission components that may facilitate transmission of signals via a television type signal (e.g., via a cable line), transmission components that may facilitate transmission of signals via a cellular network (i.e., a cellular phone), transmission components that may facilitate transmission of signals via an Internet (e.g., a modem type device), and so forth, and the claimed subject matter is not limited in these respects. Multimedia delivery system 104 may include a variety of multimedia delivery type systems such as, but not limited to, a broadcast network, a warehouse, a manufacturing facility, etc.

It should be appreciated that delivery reception component 108 may be a wide variety of predetermined locations such as, but not limited to, location of the multimedia component 102.

In order to further describe the claimed subject matter, a non-limiting example may include a user may desire to watch a television program at a different time than the scheduled broadcast. User may utilize a remote control to order the television program, and in turn, the selection may be transmitted to the broadcast station or to a third party that helps to facilitate ordering of television programs. The selected television program may then be written onto a storage medium such as an optical disc. The optical disc having the selected television program may be delivered by various mean to the user's home (i.e., a delivery address). Additionally, as previously alluded to, the optical disc may also include a tracking device. As will be described, multimedia delivery system 104 may also include a payment means for determining how and by what means the selected television program may be paid for.

In an embodiment illustrated in FIG. 1, storage medium 110 may also include an RFID type device 112 to facilitate tracking of the storage medium 110 including organization of the storage mediums. For example, intellectual property owner of the selected multimedia may desire to track demographic type information, transfer type information, and so forth of the selected multimedia.

FIG. 2 illustrates a multimedia delivery system in accordance with another embodiment. In FIG. 1, system 200 may include a multimedia delivery system 202, a transmission reception component 204, a storage system 206, a delivery system 208 that helps facilitate delivery of a storage medium 210. Further, storage medium 210 may include a tracking device 212. Together, system 200 may help to facilitate delivery of multimedia in accordance with various embodiments of the claimed subject matter.

As illustrated in FIG. 2, transmission reception component 204 may be communicatively coupled with multimedia delivery system 202, where the transmission reception component 204 may be capable of receiving a transmission of an indication of a selection of a multimedia. Multimedia delivery system 202 may provide the selected multimedia to storage system 206. Once the selected multimedia is stored on storage medium 210, storage system 206 may utilize a delivery system 208 to deliver the storage medium 210 to a predetermined location 214.

Here again, it should be appreciated that the transmission reception component may include a wide variety of components such as, but not limited to, a transmit/receive (TX/RX) device, a modem, a satellite reception base station, publicly switched telephone network (PSTN), and so forth, and accordingly, the claimed subject matter is not limited in these respects. Multimedia delivery system 202 may include a variety of multimedia delivery systems such as, but not limited to, a network broadcast station, a recording studio, a server, etc., and accordingly, not limited in these respects. Storage system 206 may also be variety of storage systems such as, but not limited to, a recording studio, an optical drive communicatively coupled to a server, etc. Delivery system 208 may include many types of delivery systems such as, but not limited to, standard mailing systems, package delivery systems, etc.

Referring to both FIGS. 1 & 2, in order to describe the subject matter, various components may be illustrated as separate components. However, it should be appreciated, as previously alluded to, that it is contemplated that the components may be arranged in a variety of manners. For example, in FIG. 2, transmission reception component 204, storage system 206, and delivery system 208 may all be included as part of the multimedia delivery system 202. Alternatively, in both FIGS. 1 & 2, various illustrated components may be further broken down. Accordingly, the various arrangements are contemplated to fall within the scope of the claimed subject matter and are not limiting in these respects. Continuing to refer to both FIGS. 1 & 2, it should also be appreciated that even though the arrows are by way of illustration shown as one direction, the arrows may flow in either direction. For example, in FIG. 1, if payment cannot be verified, multimedia delivery system 104 may utilize transmission component 106 to facilitate delivery of a message to multimedia component 102 and/or user regarding cancellation of the transaction, as in the previously described embodiment of a payment confirmation.

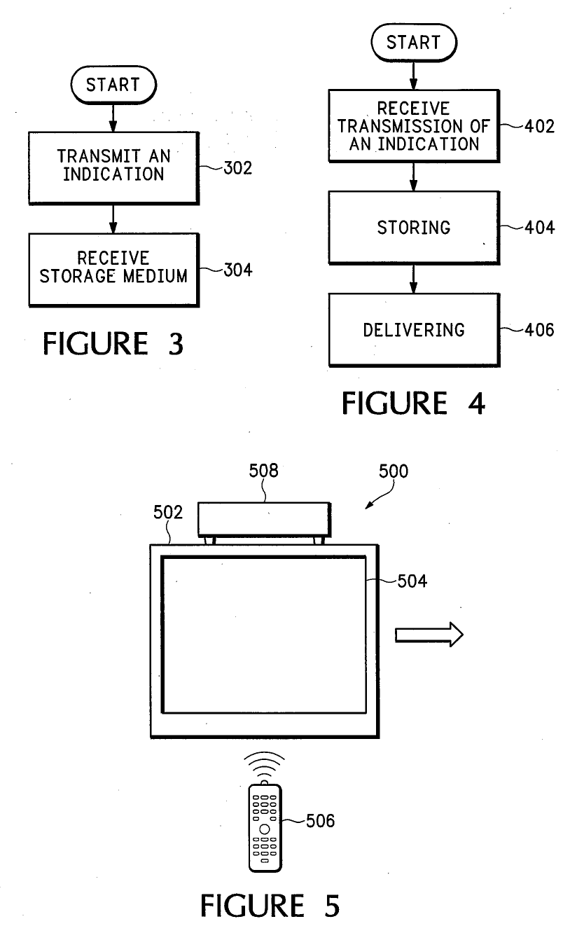

FIG. 3 illustrates an operational flow of a multimedia system in accordance with one embodiment. At block 302, an indication of a selection of a multimedia may be transmitted. A storage medium having the selected multimedia may be received at block 304.

FIG. 4 illustrates an operational flow of a multimedia system in accordance with another embodiment. At block 402, a transmission of an indication of a selection of a multimedia may be received. In response to the received indication, the selected multimedia may be stored on a storage medium at block 404. The storage medium having the selected multimedia may be delivered to a predetermined location at block 406.

Referring to both FIGS. 3 & 4, as previously described, both transmitting and receiving may involve utilization of various means such as, but not limited to, television signal, cellular network. Internet, and so forth, and accordingly, the claimed subject matter is not limited in these respects.

FIG. 5 illustrates a multimedia component in accordance with one embodiment of the claimed subject matter. In FIG. 5, multimedia component 500 may include a television 502, a remote 506, and a cable box 508. Additionally, illustrated in FIG. 5, the television 502 may be showing multimedia such as, but not limited to, a television program 504. Continuing to refer to FIG. 5, a user (not shown) may utilize remote 506 to select television program 504 (i.e., press a select button on the remote 506). The remote 506 may send a signal to the cable box 508, and in turn, cable box 508 may include a transmission component to transmit an indication of a selection of the television program 504 to a multimedia delivery system. As a result, user may receive the selected television program on a storage medium such as, but not limited to, a DVD.

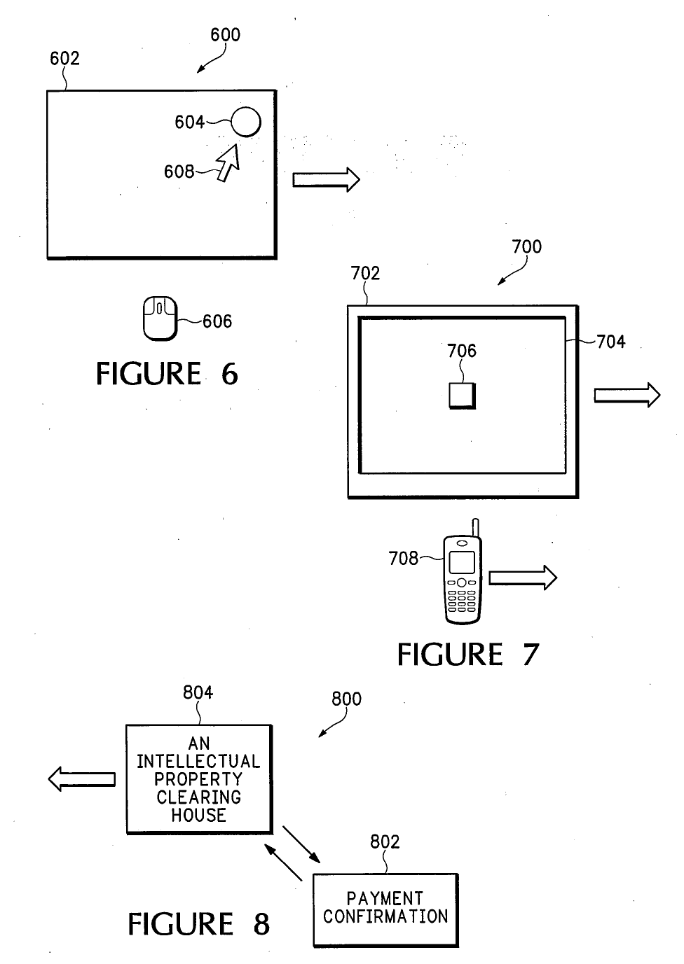

FIG. 6 illustrates a multimedia component in accordance with another embodiment of the claimed subject matter. In the illustrated embodiment, a multimedia component 600 may include a personal computer (PC), and accordingly, multimedia may be a streaming video 602. Streaming video 602 may include a selection type component such as, but not limited to, an interactive button 604. A user (not shown) may move cursor 608 with an input device such as, but not limited to, a mouse 606 to select interactive button 604. In turn, multimedia component may include a transmission component (e.g., network interface card) to transmit an indication of a selection of the streaming video for purchase. As a result, user may receive the selected streaming video on a storage medium.

FIG. 7 illustrates a multimedia component in accordance with yet another embodiment of the claimed subject matter. In FIG, 7, multimedia component 700 may include a television 702. A user (not shown) may desire to receive a television program 704 as a storage medium. Accordingly, associated with the television program, there may be provided a reference 706 such as, but not limited to, a reference number and may include a telephone number. Utilizing a wireless device 708 such as, but not limited to, a cell phone, an email capable device, etc., user may make contact using the telephone number and enter the reference number 706 facilitating transmission of an indication of a selection of a multimedia (i.e., the television program 704). As a result, user may receive the selected television program on a storage medium.

FIG. 8 illustrates an embodiment of a multimedia delivery system in accordance with one embodiment of the claimed subject matter. In FIG. 8, multimedia delivery system 800 may include a payment confirmation component 802 and an intellectual property clearing component 804. Multimedia delivery system 800 facilitates acquiring of and/or payment of appropriate licenses to copy a selected multimedia onto a storage medium. As a result, user may receive the selected multimedia respecting others' intellectual property rights including appropriate payments.

While there has been illustrated and/or described what are presently considered to be example embodiments of claimed subject matter, it will be understood by those skilled in the art that various other modifications may be made, and/or equilvalents may be substituted, without departing from the true scope of claimed subject matter. Additionally, many modifications may be made to adapt a particular situation to the teachings of claimed subject matter without departing from subject matter that is claimed. Therefore, it is intended that the patent not be limited to the particular embodiments disclosed, but that it covers all embodiments falling within the scope of the appended claims.

What is claimed is:

1. A method comprising:
transmitting an indication of selection of a multimedia; and
receiving a storage medium having the selected multimedia.

2. The method of claim 1, wherein transmitting comprises transmitting an indication of selection of a television program.

3. The method of claim 1, wherein transmitting comprises transmitting via a television signal.

4. The method of claim 1, wherein transmitting comprises transmitting via a cellular network.

5. The method of claim 1, wherein transmitting comprises transmitting via an Internet.

6. The method of claim 1, wherein transmitting comprises transmitting an indication of a selection of a moving picture experts group (MPEG) video.

7. The method of claim 1, wherein transmitting comprises transmitting an indication of a selection of an MPEG audio layer-3 (MP3) audio,

8. The method of claim 1, wherein receiving comprises receiving a disc type storage medium.

9. The method of claim 1, wherein receiving comprises receiving a storage medium having a radio frequency identification (RFID) tag.

10. A method comprising:
receiving a transmission of an indication of a selection of a multimedia;
in response to the received indication, storing the selected multimedia on a storage medium; and
delivering the storage medium to a predetermined location.

11. The method of claim 10, wherein receiving comprises receiving a transmission of a selection of a television program.

12. The method of claim 10, wherein receiving comprises receiving a transmission via a television signal.

13. The method of claim 10, wherein receiving comprises receiving an indication via a cellular network.

14. The method of claim 10, wherein receiving comprises receiving an indication via an Internet.

15. The method of claim 10, wherein receiving comprises receiving an indication of a selection of a moving picture experts group (MPEG) video

16. The method of claim 10, wherein receiving comprises receiving an indication of a selection of an MPEG audio layer-3 (MP3) audio.

17. The method of claim 10, wherein storing the selected multimedia comprises storing the selected multimedia on a disc type storage medium,

18. The method of claim 10, wherein storing the selected multimedia comprises storing the selected multimedia on a storage medium having a radio frequency identification (RFID) tag.

19. The method of claim 1 further comprising confirming payment associated with the received transmission of an indication.

20. A system comprising:
a multimedia component, the multimedia device communicatively coupled with a multimedia delivery system;
a transmission component communicatively coupled with the multimedia device and the multimedia delivery system, the transmission component capable of transmitting an indication of a selection of multimedia to the multimedia delivery system; and
a delivery reception component, the delivery reception component capable of receiving a storage medium having the selected multimedia from the multimedia delivery system.

21. The system of claim 20, wherein the multimedia component comprises a television.

22. The system of claim 20, wherein the multimedia component comprises a computing device.

23. The system of claim 20, wherein the transmission component comprises a television cable box.

24. The system of claim 20, wherein the transmission component comprises a wireless device.

25. The system of claim 24, wherein the transmission component comprises a cellular phone.

26. The system of claim 24, wherein the transmission component comprises a email capable wireless device.

27. The system of claim 20, wherein the delivery reception component comprises a delivery address.

28. A system comprising:
a multimedia delivery system;
a transmission reception component communicatively coupled with the multimedia delivery system, the transmission reception component capable of receiving a transmission of an indication of a selection of a multimedia;
a storage system, the storage system capable of storing the selected multimedia on a storage medium; and
a delivery system, the delivery system capable of delivering the storage medium having the selected multimedia to a predetermined location.

29. The system of claim 28, wherein the multimedia delivery system comprises a television broadcast station.

30. The system of claim 28, wherein the multimedia delivery system comprises a manufacturing facility.

31. The system of claim 28, wherein the multimedia delivery system comprises a network server.

32. The system of claim 28, wherein the transmission reception component comprises a modem.

33. The system of claim 28, wherein the transmission reception component comprises a satellite reception base station.

34. The system of claim 28, wherein the storage system comprises an optical drive.

35. The system of claim 28, wherein the storage medium comprises an optical disc.

36. The system of claim 28, wherein the storage medium comprises a hardware type storage device.

37. The system of claim 28, wherein the delivery system comprises a mailing system.

38. The system of claim 28, wherein the delivery system comprises a package delivery system.
